(19) United States
(12) Patent Application Publication
(10) Pub. No.: US 2013/0309974 A1
(43) Pub. Date: Nov. 21, 2013

(54) PORTABLE ELECTRONIC DEVICE

(71) Applicant: ASUSTEK COMPUTER INC., Taipei (TW)

(72) Inventors: Cheng-Yao HUANG, Taipei (TW); Pei-Yang LIN, Taipei (TW); Ren-Jiun HUANG, Taipei (TW); Chiu-Chuan HO, Taipei (TW); Ping-Yen TSAI, Taipei (TW)

(73) Assignee: ASUSTeK COMPUTER INC., Taipei (TW)

(21) Appl. No.: 13/889,813

(22) Filed: May 8, 2013

(30) Foreign Application Priority Data
May 16, 2012 (CN) 201210152069.7

(51) Int. Cl. H04W 4/00

(52) U.S. Cl. CPC H04W 4/008
USPC 455/41.2

(57) ABSTRACT

A portable electronic device is disclosed. The portable electronic device includes a housing, an input module, a near distance communication chip and a near distance communication module. The input module includes a near distance communication antenna. The near distance communication chip is electronically connected with the near distance communication antenna. The near distance communication module is disposed at the housing and communicates with the near distance communication chip via the near distance communication antenna. A communication method of a portable electronic is also provided thereof.

### CROSS-REFERENCE TO RELATED APPLICATION

This application claims the priority benefit of application no. 201210152069.7 filed in People's Republic of China on May 16, 2012. The entirety of the above-mentioned patent application is hereby incorporated by reference herein and made a part of specification.

### BACKGROUND OF THE INVENTION

1. Field of the Invention

The invention relates to an electronic device integrating near distance communication technology.

2. Description of the Related Art

In recent years, wireless communication technology has greatly developed, and it facilitates people in various aspects of the modem life, especially in near distance communication technology. With no need for touching, power and complicated matching set Which is necessary in blue tooth communication, near distance communication technology becomes popular and a new favorite.

Generally, near distance communication technology includes radio frequency identification (RFID), Zigbee, near field communication (NFC) and other types. Nowadays, a small and thin chip with near distance communication function can replace a heavy coin purse and a large bunch of keys. And inconvenience both in e-commerce and identity authentication can be improved.

However, conventionally, to apply near distance communication technology in a notebook, an external read device is necessary for inserting or laying a chip therein, it is rather inconvenient and cannot integrate both the read and being read function. Furthermore, the laptop usually needs an extra slot or an additional interconnecting circuit for the operation of the read device, which certainly increases the cost.

### BRIEF SUMMARY OF THE INVENTION

The invention provides a portable electronic device. With no need for other external devices, even with no need for additional dedicated circuits, the portable electronic device can integrate with near distance communication technology to enhance added value of the device and provide additional functions such as identification, e-commerce or data transmission.

The invention provides a portable electronic device, which includes a housing, an input module, a near distance communication chip and a near distance communication module. The input module includes a near distance communication antenna. The near distance communication chip is electronically connected with the near distance communication antenna. The near distance communication module is disposed at the housing, and communicates with the near distance communication chip via the near distance communication antenna.

These and other features, aspects and advantages of the present invention will become better understood with regard to the following description, appended claims, and accompanying drawings.

### BRIEF DESCRIPTION OF THE DRAWINGS

FIG. 1A is an exploded diagram showing the exterior of a portable electronic device in an embodiment;

FIG. 1B is a system block diagram showing one form of the integrated portable electronic device in FIG. 1A;

FIG. 1C and FIG. 1D are system block diagrams showing other forms of the integrated portable electronic device in FIG 1A, respectively;

FIG. 2A is a system block diagram showing a portable electronic device in another embodiment; and

FIG. 2B and FIG. 2C are system block diagrams showing other forms of the integrated portable electronic device in FIG. 2A, respectively.

### DETAILED DESCRIPTION OF THE EMBODIMENTS

A portable electronic device and a method for controlling thereof in an embodiment will be disclosed accompanying drawings, and the same symbols denote the same components.

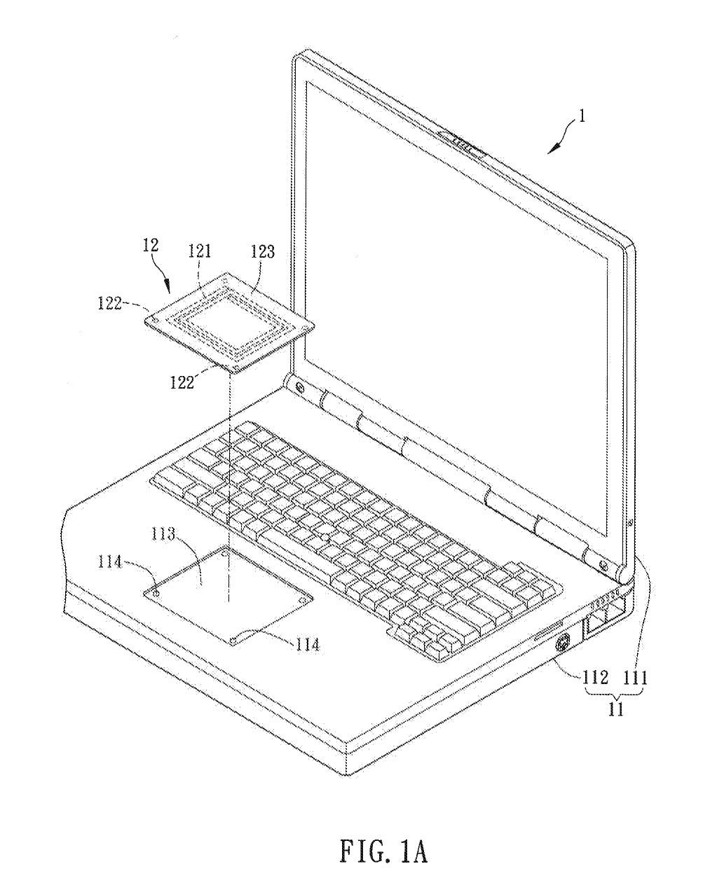

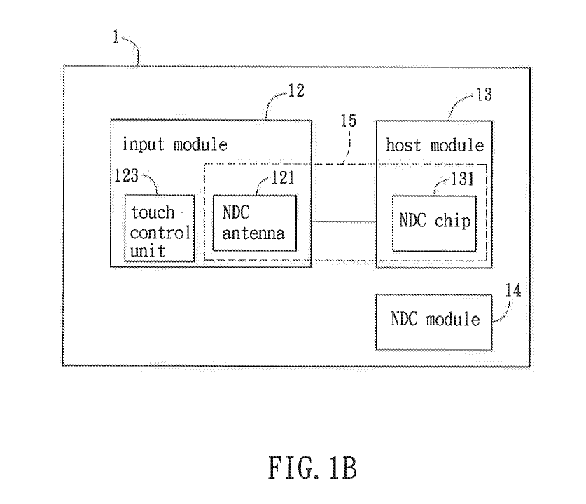

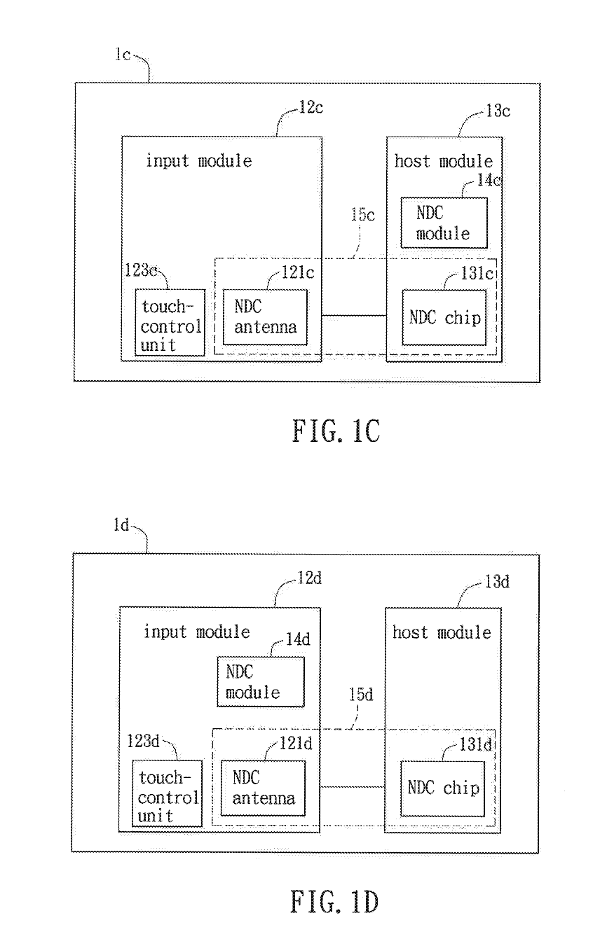

FIG. 1A is an exploded diagram showing the exterior of a portable electronic device in an embodiment. A portable electronic device may be a notebook computer, a tablet computer, a smartphone or any other devices having same functions. As shown in FIG. 1A, the portable electronic device is a notebook computer in this embodiment. The portable electronic device 1 includes a housing 11 and an input module 12. The housing includes a top housing 111 covering the screen panel and a main housing 112 covering main components, which is not limited herein.

In an embodiment, the input module 12 may be but not limited to a touch-control panel, a keyboard or a touch-control display panel. The input module 12 may be detachably installed or fixed in the groove 113 of the main housing 112, and the detachably assembly mode may be achieved by magnetic force or other connection means, which is not limited herein.

The portable electronic device includes a near distance communication chip and a near distance communication module. The near distance communication module is disposed in the housing, and the near distance communication module can be installed in different ways as long as it is electronically connected to a near distance communication antenna.

FIG. 1B is a system block diagram showing one form of the integrated portable electronic device in FIG. 1A. As shown in FIG. 1B, the portable electronic device 1 includes a host module 13 and a near distance communication module 14. The host module 13 may be a mainboard installed in the main housing 112 of the portable electronic device 1, and the near distance communication module 14 also may be installed in the main housing 112.

As shown in FIG. 1A and FIG. 1B, the input module 12 in this embodiment includes a near distance communication antenna 121. The near distance communication antenna 121 is installed on the input module 12 with looping around periphery of the input module 12 a time or several times. The near distance communication antenna 121 also may be installed in the middle of the input module 12 in concentric circle or other shapes, which is not limited herein.

The near distance communication in this embodiment utilizes the communication technology in short distance, but not limit to any substantial technology of exchanging data or information. As for the range of the near distance communication, zero to five meters is good, zero to three meters is better, and zero to half meter is much better. Wherein zero meter means that at least part of two parts are directly touched. According with the foregoing the near distance communication technology includes radio frequency identification (RFID), Zigbee, near field communication (NFC) or other developed technologies based on the foregoing three technologies, which is not limited herein.

As shown in FIG. 1A and FIG. 1B, the groove 113 in this embodiment has four pins 114, which are electronically connected with the host module 13. The input module 12 has four corresponding contacts 122 which are respectively electronically connected with a touch-control unit 123 and the near distance communication antenna 121. Therefore, when the input module 12 is connected with the groove 113, the input module 12 and the near distance communication antenna 121 can be electronically connected with the host module 13. Since the host module 13 includes a near distance communication chip 131, when the input module 12 and the near distance communication antenna 121 are electronically connected with the host module 13, the near distance communication antenna 121 is simultaneously electronically connected with the near distance communication chip 131 to build a near distance communication module 15. In this embodiment, as long as the touch-control unit 123 shares a connection cable or a flexible cord with the near distance communication antenna 121, they are connected to the host module 13 and the near distance communication chip 131, respectively. Therefore, the integration of the near distance communication not only adds more additional functions to the portable electronic device but also keeps low cost and spatial configurations.

The near distance communication module 15 made up by the near distance communication antenna 121 and the near distance communication chip 131 electronically connected with each other is called a first near distance communication module, and the near distance communication module 14 of the portable electronic device is regarded as the second near distance communication module herein after.

Since the second near distance communication module also has an antenna, after the input module 12 is electronically connected with the host module 13 and the first near distance communication module is formed, the second near distance communication module can communicate with the first near distance communication module by transmitting data or signals with the near distance antenna of the first near distance communication module, which is called the internal communication of the portable electronic device.

Moreover, the first and second near distance communication module also can respectively or corporately transmit data or signals with other near distance communication modules, which makes the portable electronic device have external communication function with other devices or systems.

As for the internal communication, for example, it can be applied to identification and security control, that is, only when the held input module is the right one, the near distance communication will be built and the identification data stored in the near distance communication can be recognized by the host module to enable locked functions. When the input module is detachably installed in the housing, it works more efficaciously. Different input modules with different pins or supportive wirings are provided for different users according to users' identities, whether the input module can be exactly electrically connected with the host module will be the doorsill, that is, different security levels can be set at open-use type devices.

After the input module integrated with the main housing, near distance communication with external may be built in different ways. For example, one way is that the first near distance communication device is regarded as a storage card, near distance communication is built when the portable electronic device directly approaches or touches external communication devices. Another way is that the second near distance communication device is regarded as a data transmission device, and the portable electronic device wirelessly transmits data with external devices or systems via the near distance communication technology.

FIGS. 1C and FIG. 1D are system block diagrams showing other forms of the integrated portable electronic device in FIG. 1A, respectively. As shown in FIG. 1C, the portable electronic devices in FIG. 1C and FIG. 1B have similar components and structures. The difference therebetween is that the near distance communication module 14c, namely, a second near distance communication module is installed on the host module 13c to further decrease additional components and circuits. As shown in FIG. 1D, similarly, the portable electronic devices id in FIG. 1D and FIG. 1B have similar components and structures. The difference therebetween is that the near distance communication module 14d, namely, the second near distance communication module is installed at the input module 12d, and thus the input module 12d have additional near distance communication function, and it may be used as a receiving end receiving signals from other devices.

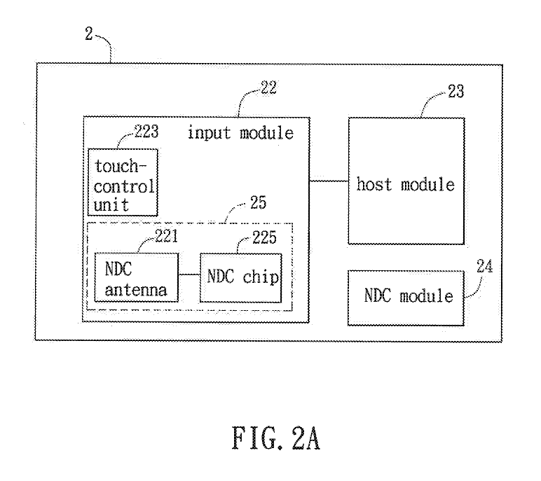

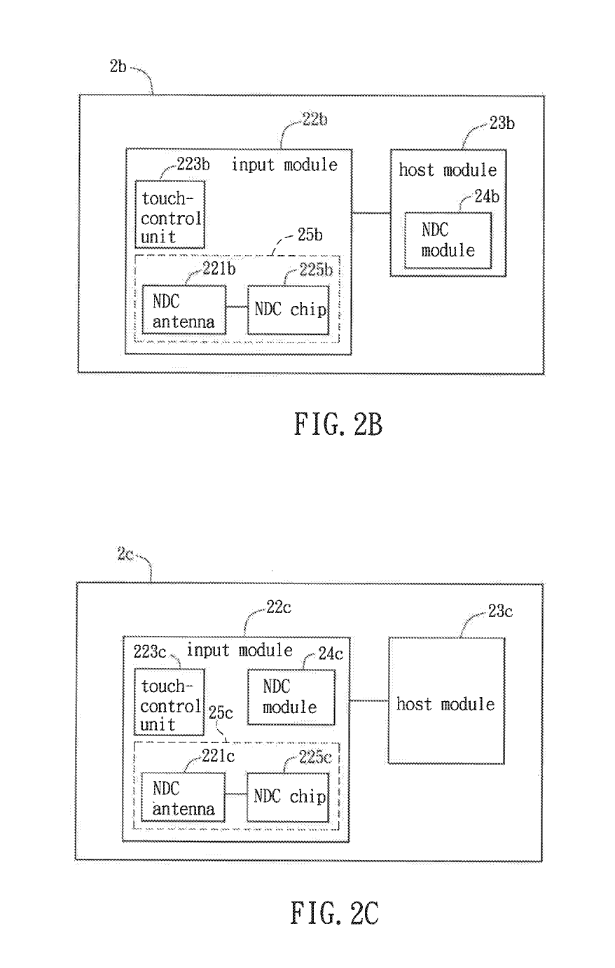

FIG. 2A is a system block diagram showing a portable electronic device in other embodiment. As shown in FIG. 2A, in this embodiment, components, structures, and circuit connections of the portable electronic device 2 are similar to those in aforementioned embodiments. For example, the portable electronic device 2 includes a host module 23 installed in the housing, and an input module 22 is electronically connected with the host module 23, the related details can be referenced to aforementioned descriptions, which is omitted herein. The difference therebetween is that the near distance communication chip disposed in the host module 13 of aforementioned embodiments is installed in the input module 22 in this embodiment. Additionally, the near distance communication chip 221 in the input module 22 is electronically connected with the near distance communication chip 225 to form a first near distance communication module 25, and the first near distance communication module 25 can internally communicates with the corresponding near field communication module 24 of the portable electronic device 2 which is namely the second near distance communication module. Moreover, both the first near distance communication module 25 and the second near distance communication module 24 can respectively or corporately exchange information or data with other external devices or systems. The touch-control unit 223 receives a touch-control event to control the portable electronic device.

Similarly, the input module 22 may be detachably installed or fixed at the housing. When the input module 22 is detachable, the input module 22 can be detached when the portable electronic device is not operated, and the input module 22 can be used as medium for identification, e-commerce or data transmission by using the card structure (such as that in FIG. 1A) and the near distance communication function, which is very convenient. When the portable electronic device 2 needs to be operated, the input module 22 is approached or integrated to the portable electronic device 2 to make the first near distance communication module 25 communicate with the second near distance communication module to recognize identity, for enabling the device or the lock functions.

FIG. 2B and FIG. 2C are block diagrams showing other forms of the integrated portable electronic device in FIG. 2A, respectively. As shown in FIG. 2B, the portable electronic device 2h has similar components and structures. The difference therebetween is that the near distance communication module 24b, namely, a second near distance communication module is installed on the host module 23b to further decrease additional components and circuits. As shown in FIG. 2C, similarly, the portable electronic device 2c has the similar components and structures. The difference therebetween is that the near distance communication module 24c, namely, a second near distance communication module is installed on the host module 23b. Consequently, the components needed in the near distance communication module can be made in a modular way to reduce the cost.

In sum, the portable electronic device in embodiments integrates the near distance communication technology into the input module to enhance added value. Specifically, the input module may include a near distance communication antenna. Consequently, with original circuit structures of the input module and the host module, by cooperating with the near distance communication chip in the host module, the input module can communicate with another near distance communication module in the device. The input module also may both include the near distance communication antenna and a near distance communication chip. As a result, the input module itself has the near distance communication function. Therefore, it can both communicates with the internal near distance communication module of the portable electronic device and other external near distance communication devices, which adds device with added value and additional functions such as identification, e-commerce or other applications.

In the embodiments, the near distance communication module is installed, in the housing of the device, and the input module integrates with the near distance communication function, which can solve inconveniences in connecting with other external devices and save the cost and space for configuring additional circuits. Additionally, when input module both has a chip and an antenna, it can be detached from e portable electronic device and used as a smart card for shopping, commuting or identification.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A portable electronic device, comprising:
a housing;
an input module with a near distance communication antenna;
a near distance communication chip electronically connected with the near distance communication antenna; and
a near distance communication module disposed at the housing and communicating with the near distance chip via the near distance antenna.

2. The portable electronic device of claim 1, further comprising;
a host module disposed in the housing and electronically connected with the input module.

3. The portable electronic device of claim 1, wherein the near distance communication chip is installed in the host module.

4. The portable electronic device of claim 1, wherein the near distance communication chip is installed in the input module.

5. The portable electronic device of claim 1, wherein the input module is detachably installed or fixed in the housing.

6. The portable electronic device of claim 1, wherein the host module is electronically connected with the input module via pins and contacts.

7. The portable electronic device of claim 1, wherein the input module includes keyboard, touch display panel, and touch panel,

8. The portable electronic device of claim 1, wherein the near distance communication includes Radio Frequency Identification (RFID), ZigBee and Near field communication (NFC).

9. The portable electronic device of claim 1, wherein the near distance communication chip stores identification data.
